(19) United States
(12) Patent Application Publication
(10) Pub. No.: US 2015/0041166 A1
(43) Pub. Date: Feb. 12, 2015

(54) MODULAR ELECTRO-MECHANICAL DEVICE

(71) Applicants: Benjamin Luke Van Der Linde, Heatherton (AU); David Scrimshaw, Heatherton (AU); Paul Francis Connor, Heatherton (AU); Paul Miller, Heatherton (AU); Ben Eyers, Heatherton (AU); Sion Netzler, Heatherton (AU); Lucas Lastman, Heatherton (AU)

(72) Inventors: Benjamin Luke Van Der Linde, Heatherton (AU); David Scrimshaw, Heatherton (AU); Paul Francis Connor, Heatherton (AU); Paul Miller, Heatherton (AU); Ben Eyers, Heatherton (AU); Sion Netzler, Heatherton (AU); Lucas Lastman, Heatherton (AU)

(73) Assignee: DEMAIN TECHNOLOGY PTY LTD, Heatherton, Victoria (AU)

(21) Appl. No.: 14/240,589

(22) PCT Filed: Aug. 25, 2011
(86) PCT No.: PCT/AU2011/001102

§ 371 Date: Oct. 21, 2014

(51) Int. Cl. B25F 5/02; B25F 3/00; F16C 11/10; H01R 4/64

(52) U.S. Cl. CPC B25F 5/02; H01R 4/64; B25F 3/00; F16C 11/10
USPC 173/29; 439/369; 29/428; 403/83

(57) ABSTRACT

The invention relates to a connection for releasably connecting two parts of an electro-mechanical device, the connection including: a first connecting portion associated with a first part, and a second connecting portion associated with a second part, such that engagement of the first and second connecting portions imparts bias between the two parts, and a retention means suitable for maintaining the bias between the two parts.

### FIELD OF INVENTION

The present invention relates to the field of electro-mechanical devices. In particular the present invention relates to the field of electro-mechanical devices such as domestic appliances including hand-held tools.

In one form, the invention relates to a connection for two parts of an electro-mechanical device. In one particular aspect the present invention is suitable for use as a connection for a controller and a motorised body adapted to drive an operating component.

It will be convenient to hereinafter describe the invention in relation to power tools such as those used by tradesmen, handymen and hobbyists, however it should be appreciated that the present invention is not so limited and may be used for a wide range of electro-mechanical devices. For example, the present invention may be used in relation to kitchen appliances.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

A wide range of hand held power tools are available for an enormous number of different applications. Tradesmen often own numerous handheld devices such as power drills, AC high speed drills, hammer drills, angle grinders, circular saw, jigsaws, sanders and so forth which may be connected to a power source or battery operated. Similarly, as the cost of power tools has diminished individuals in a domestic environment often possess a wide variety of power tools for DIY projects or hobbies.

In order to overcome the inconvenience and physical limitation of having a power cord attached to a power tool, cordless power tools adapted to receive non-rechargeable or rechargeable batteries were developed. Non-rechargeable batteries were typically loaded into a recess in the power tool handle and replaced when they were flat. Due to their need to be regularly replaced, some power tools have rechargeable batteries that are removably located in the power tool, or alternatively, the batteries can be plugged into a recharger while located in the handle.

Design of power tools (both those operating from a power source and those that are battery operated) has further progressed to include the use of a single handle that can be removably connected to a range of attachments for different applications. For example a single controller could be attached to a drill body, sander body, jigsaw body, grinder body and so forth. This modularity, particularly the ability to remove a handle from a power tool reduces the overall size of each unit, allowing more units to be stored in a given volume of space such as a shipping container (saving freight costs), or a retail shelf (allowing retailers to maximise stock and improve return on shelf or floor space cost) and simplifying inventory and reducing the amount of storage needed by users. Given that many people now live in apartments or town houses, the ability to more efficiently store tools in a small space in the home environment can be very appealing to home handymen and hobbyists.

For example U.S. Pat. No. 6,286,611 (Black & Decker Inc) discloses a power tool including a motor mounted in a handle, the handle being adapted for connection to any one of a plurality of tool head attachments to form a tool dedicated for a particular job. Typically each tool head attachment has a drive mechanism that engages a spindle cog. The spindle has a male cog attachment for mesh engagement with a female cog of a drive mechanism on the power tool head. The tool head is kept in connection with the drive mechanism by a locking mechanism.

U.S. Pat. No. 6,796,389 (Snap-on Incorporated) teaches the use of a handle grip which slides over a handle of a tool body where it is retained by flanges that resiliently clip into grooves in the handle.

U.S. Pat. No. 6,181,032 (Black & Decker Inc) relates to an interface for releasably connecting a power control module or battery pack to an electrical tool. A power control switch is located on the electrical tool and is actuated by a manual trigger on the power control module/handle. The interface is formed by sliding connection between the power control module and electrical tool via a pair of dovetail connections with interlocking flanges. The trigger operates a linkage that reaches through the interface plane into the tool to operate a switch located within the tool.

U.S. Pat. No. 7,414,211 (C Enterprise HK Ltd) relates to a cordless power tool having a handle that can house multiple rechargeable cylindrical batteries. Complementary female and male connectors provided respectively on the power handle and on the electrical tool permit sliding engagement and disengagement, the male connector having electrical contact means exposed thereon for engagement with the electrical contacts on the power handle.

U.S. Pat. No. 6,443,675 (Roto Zip Tool Corp) relates to a hand held power tool having a motor housing and detachable handle bearing a manually operable trigger switch. The trigger switch is coupled to a motor controller within the motor housing without use of a direct mechanical connection so as not to interfere with the easy and quick attachment and detachment of the handle to and from the housing. Fixed housing mounting structures such as housing apertures are formed in the tool housing and positioned therein for receiving extending tabs (preferably hook shaped to hook into the apertures) and a rotatable rod which extend from the ends of the handle. The end of the rod preferably includes one or more distal radially extending portions that fits through slots in the tool housing and can be oriented to resist removal of the handle from the power tool.

US Patent application 2006/0037766 (Gass & D'Ascenzo) relates to an electrically powered hand drill/driver having a housing containing a motor and a handle and a power control module to deliver power to the motor. The housing and power control module are connected by a ridge that fits in a slot, held in place by a locking member.

One of the problems associated with modular power tools of the prior art, or more particularly their connections, is that they permit a degree of movement between the parts. A user typically notices a ‘wobble’ between the parts. Any instability in the connection of an electro-mechanical device tends to cause concern in the mind of a user, particularly concerns relating to electric shock. This is particularly so with respect to alternating current (AC) devices which are of higher energy than direct current (DC) devices. Furthermore, any movement at electrical contacts between the parts can cause arcing, accelerated wear and concomitant decrease in efficiency.

### SUMMARY OF INVENTION

An object of the present invention is to provide an improved connection between parts of an electro-mechanical device. Another object is to stabilise the connection between parts of an electro-mechanical device such that the user does not perceive any movement.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided a connection for releasably connecting two parts of an electro-mechanical device, the connection including;
a first connecting portion associated with a first part, and a second connecting portion associated with a second part, such that engagement of the first and second connecting portions imparts bias between the two parts, and
a retention means suitable for maintaining the bias between the two parts.

The connection would be suitable for use in electro-mechanical devices such as a domestic appliance, preferably a power tool. For example the power tool could be use with one of a wide range of working elements, such as drill bits, screw drivers, cutting blades, saws, files, sanding papers/belts and combinations thereof. Of course, the person skilled in the art will readily appreciate that the connection would also be suitable in other domestic appliances such as food processors which are attached to a wide range of working elements such as beaters, mixers, slicers, cutting blades and dough hooks.

The person skilled in the art will recognise that bias can be created by a number of means including interference fit, compression of a component, application of leverage, use of a biasing element such as a spring or combinations thereof. It is particularly preferred that the bias substantially stabilises an interface between electrical contacts in the first part and electrical contacts in the second part. The biasing means may additionally operate as the retention means.

In a preferred embodiment, engagement between the first connecting portion and the second connecting portion forms a pivot, such as a hinge. Alternatively or in addition, the engagement of the parts may comprise interference fit, or compress a spring. In a particularly preferred embodiment, the connecting portions are of complementary shape.

When the engagement between the first connecting portion and the second connecting portion forms a hinge, the hinge may have a longitudinal axis substantially parallel to the direction of force applied to the power tool during use. More preferably, the hinge has a longitudinal axis substantially perpendicular to the direction of force applied to the power tool during use. The person skilled in the art will appreciate that the terms ‘parallel’ and ‘perpendicular’ are intended to indicate approximate relative positions and are not absolute measurements.

### Retention Means

The retention means may be any convenient device for maintaining the bias created by engagement of the first part and second part. The retention means may, for example comprise a slide, bayonet, plug, cam, latch or snap lock or other type of closure. For example the retention means may be a latch comprising a projection on one part that fits into a corresponding aperture in the other part. The latch may be spring loaded. A latch actuator may be used to change the latch from a first, projecting position to a second, retracted position.

### First Part

Typically the first part includes a power source and power actuator. The power source may supply alternating current (AC) or direct current (DC) power. The power supplied may be derived from an energy storage device such as one or more batteries or fuel cells. Alternatively the power may be supplied from an energy generating device such as a generator or drawn from the mains.

Preferably the first part performs the function of a handle and at least part is appropriately shaped for this purpose. For example the housing may be elongate and shaped to provide a hand grip.

The actuator may be any conventional actuator such as a push-button or slide. In addition to the actuator, the first part typically also includes a means to disable the power actuator when the first part is partly or fully disconnected from the second part. In addition a mechanical lock may be provided resist unwanted separation of the first part from the second part when the actuator is ‘on’. For example, an interlock operator on the first part may be moved between a guard position where it resists operation of the actuator, and at least one armed position, in which it allows the actuator to be operated. The actuator may perform other additional functions.

The first part be associated with, or enclose one or more operating components such as an electrical flow controller, electrical noise suppression component, FET (for DC), forward/reverse lever or a heat sink.

The first part may include one or more indicators that indicate the status of various features or operating components of the first part. In a particularly preferred embodiment the power actuator is associated with an on/off indicator such as a light, more preferably an LED indicator.

When the first part uses mains power as a source of electricity, it will necessarily include a power cord formed of entwined electrical wires within at least one insulating jacket. Typically the power cord emerges from a port in the housing of the first part. In a particularly preferred embodiment of the first part, the jacket and port are configured to form a joint that facilitates bending of the cord. For example, the part of the jacket adjacent the port may be expanded to form a generally spherical shape that fits in a correspondingly curved portion of the port. Thus a pivot is formed.

### Second Part

Typically the second part includes a motor and is adapted to carry a working element. The working element may be releasably carried on the second part. Depending on the nature of the working element, when the first part and the second part of the electro-mechanical device are connected they may perform any one of a number of functions. For example, the device may be chosen from the group comprising drilling apparatus, cutting apparatus, grinding apparatus, impact drilling apparatus, screw driving apparatus and combinations thereof.

In another aspect of embodiments described herein there is provided a connection for releasably connecting two parts of a power tool, the connection including:
a first connecting portion associated with a first part, and a second connecting portion associated with a second part, such that engagement of the first and second connecting portions substantially resists movement between the two parts, and
a retention means suitable for maintaining resistance of movement between the two parts.

In a further aspect of embodiments described herein there is provided a method of connecting two parts of a power tool, using the connection of claim 1 including the steps of;
i. engaging the first connecting portion with the second connecting portion such that bias is imparted between the two parts, and
ii. simultaneously or subsequently, applying the retention means to maintain bias between the two parts.

The connection of the present invention may be used with any convenient configuration of first part and a second part of an electro-mechanical device. In a particularly preferred embodiment the first part and second part are suitable for use with the storage system and carry cabinets described in co-pending patent application PCT AU200100021. For example, the first part or second part may be supplied to wholesalers, retailers and purchasers with a storage dock—a reusable packaging that serves as a dock for the part when it is in the carry cabinet. The carry cabinet is also adapted to store or transport auxiliary components used with the tool.

Other aspects and preferred forms are disclosed in the specification and/or defined in the appended claims, forming a part of the description of the invention.

In essence, embodiments of the present invention stem from the realization that a bias is required to secure corresponding electrical contacts when two parts of an electro-mechanical device are used together.

Advantages provided by the present invention comprise the following:
removes perceived movement between parts of a device;
provide a more rigid, integral feel for a modular device;
reduces wear and tear on electrical contacts, increasing longevity of the device;

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates a side view of two separated parts of an electro-mechanical device according to the present invention;

FIG. 2 illustrates a side view of a power drill according to the present invention as the first part is engaging a second part (FIG. 2a) and one end of the power drill viewed in cross section along A-A′ (FIG. 2b);

FIG. 3a illustrates a side view of a power drill according to the present invention having a first part fully connected to a second part; FIG. 3b illustrates one end of the power drill of FIG. 3a viewed in cross section along B-B′;

FIG. 4 illustrates an end view of a further embodiment of a power drill showing the two parts;

FIG. 5 illustrates an end view of the power drill of FIG. 4 when the two parts are connected;

FIG. 6 illustrates a further embodiment of a power drill of the present invention viewed in cross section across the end and including two latches, shown in the disengaged position (FIG. 6a) and in the engaged position (FIG. 7b);

FIG. 7 illustrates enlarged views of the latches of the embodiment shown in FIG. 6 in the disengaged position (FIG. 7a) and the engaged position (FIG. 7b) positions;

FIG. 8 illustrates a further embodiment of an electro-mechanical device (angle grinder) according to the present invention viewed from the side in the disengaged position (FIG. 8a) and viewed in longitudinal cross section along C-C′ (FIG. 8b).

### DETAILED DESCRIPTION

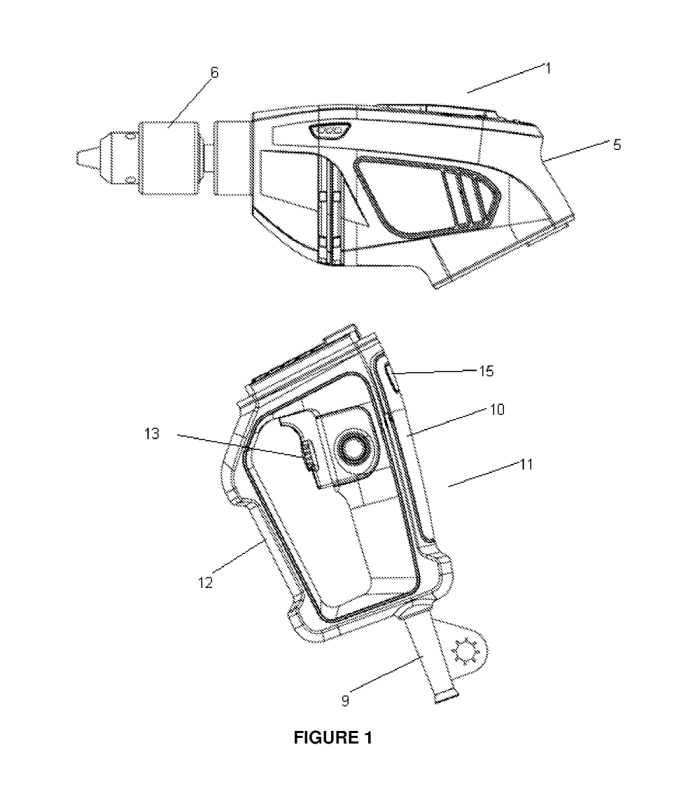

FIG. 1 illustrates a side view of an electro-mechanical device (1) (power drill) according to the present invention having a second part (5) comprising a drill body and chuck (6) for holding a working element such as a drill bit, and a first part (10) comprising a controller providing a source of power via the power cord (9).

The first part (10) comprises a handle having a grip (11), hand guard (12) and power actuator in the form of a trigger (13). An interlock operator button (15) on the first part may be moved between a guard position where it resists operation of the trigger (13), and at least one armed position, in which it allows the actuator to be operated. In this view the two parts (5 and 10) are not connected.

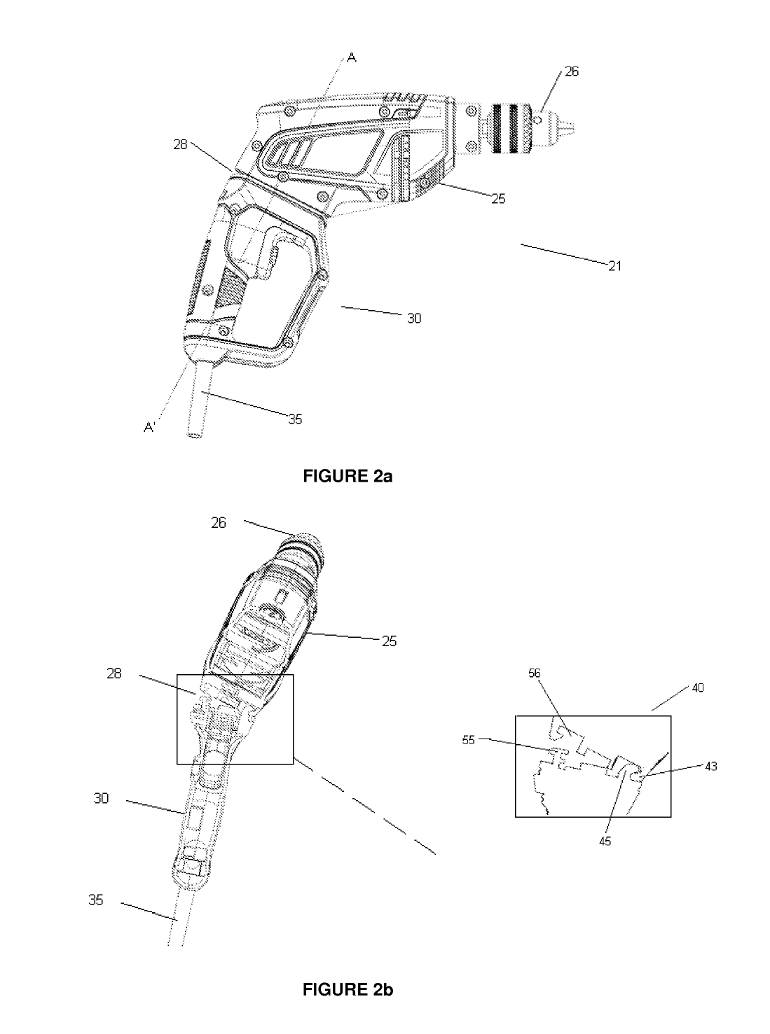

FIG. 2a illustrates a side view of another power drill (21) according to the present invention having a second part (25) comprising a drill body and chuck (26), and a first part (30) comprising a controller and including a grip (31), hand guard (32) and power actuator trigger (34). The power drill is powered by mains electricity and therefore also includes a power cord (35). In this view the two parts have been brought into engagement, but not yet fully connected.

FIG. 2b illustrates one end of the power drill (21) of FIG. 2a viewed in cross section along A-A′ of FIG. 2a, with the connection (40) magnified to show detail. In particular, the magnified portion shows engagement between the complementary curved shapes of the second connecting portion (43) and the first connecting portion (45) when the second part (25) and first part (30) are brought into engagement.

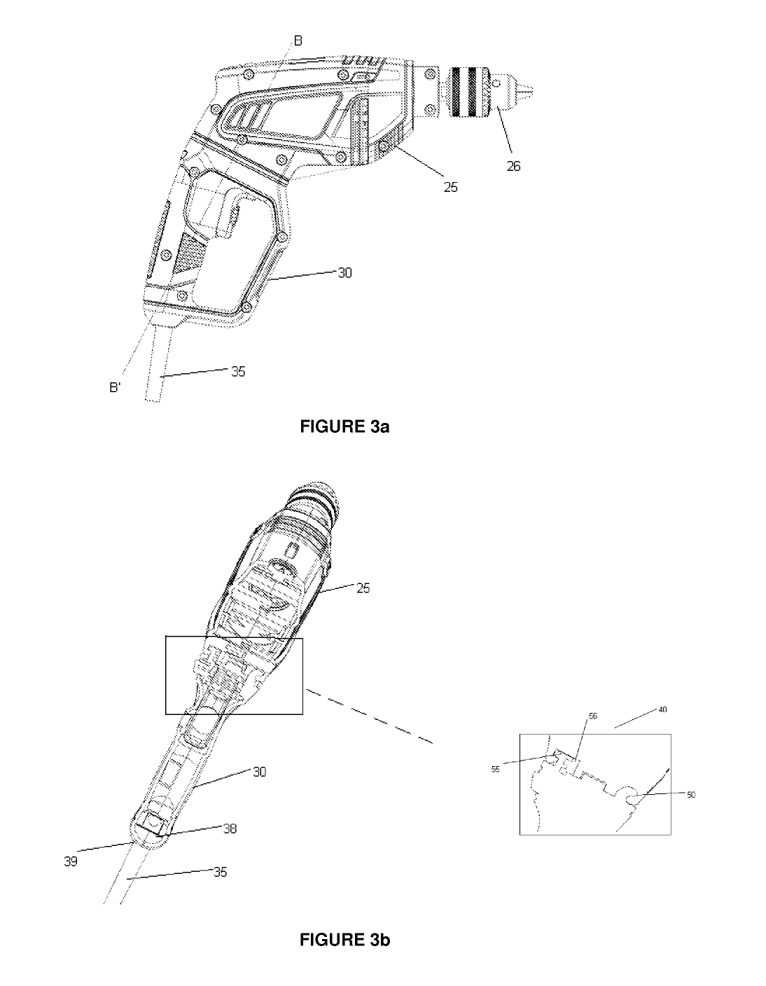

FIG. 3a illustrates a side view of the power drill (21) of FIG. 2a, with the first part (30) fully connected to the second part (25).

FIG. 3b illustrates one end of the power drill (21) of FIG. 3a viewed in cross section along B-B′ with the connection (40) expanded to show detail. In particular, the magnified portion shows the complementary curved shapes of the first connecting portion (43) and the second connecting portion (45) fully engaged to form a hinge (50) and thus imparting bias between the first part (30) and the second part (25). In this embodiment the hinge has a longitudinal axis perpendicular to the direction of force applied to the power tool during use. A retention means comprising a projection (55) of the second part (30), is releasably received within a recess (56) in the first part (25) and maintains the bias between the two parts, resisting movement therebetween.

In this embodiment the polymer jacket of the power cord (35) is configured to form a pivot (38) in the vicinity of the port (39) where it enters the second part (30). The ball joint facilitates bending of the power cord (35), particularly when coiled or looped during storage of the power drill.

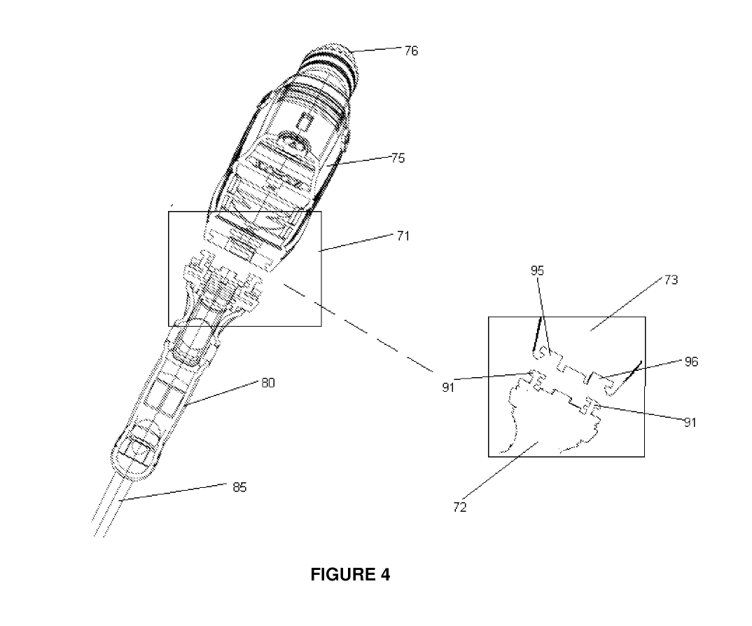

FIG. 4 illustrates another power drill (71) according to the present invention viewed in cross section across the end. In this view the two parts are separate. The first connecting portion (72) and second connecting portion (73) are magnified to show detail. The power drill (71) has a first part (80) comprising a controller and including a grip, hand guard and power actuator trigger and a second part (75) comprising a drill body and chuck (76). The power drill is powered by mains electricity and therefore also includes a power cord (85).

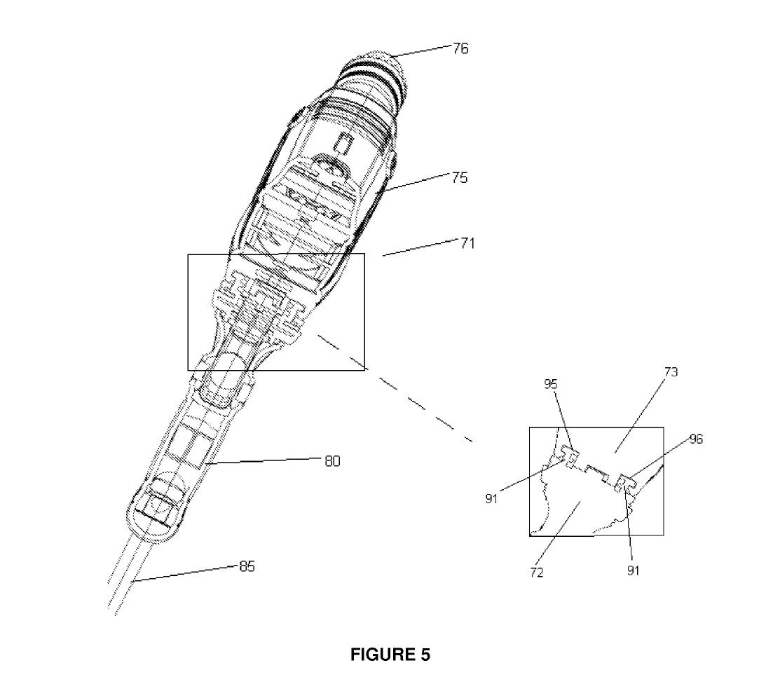

FIG. 5 illustrates the power drill (71) of FIG. 4 according to the present invention again viewed in cross section across one end. The connection is expanded to show detail of the engagement between the first connecting portion (72) and second connecting portion (73). In this embodiment when the first connecting portion (72) and second connecting portion (73) are engaged, the retention means also imparts the bias between the first part (80) and second part (75). The retention means in this embodiment comprises two projections (91, 92) on the first body, which are removably retained in corresponding recesses (95, 96) in the second body.

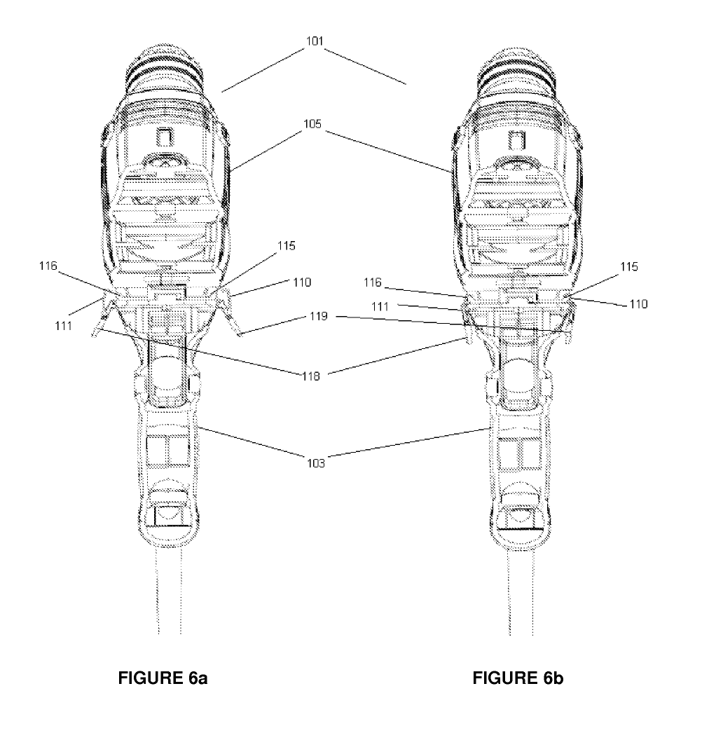

FIG. 6 illustrates a further embodiment of a power drill (101) according to the present invention viewed in cross section across the end. The power drill (101) is depicted with the first part (103) and second part (105) separated (FIG. 6a) and in engagement (FIG. 6b). In this embodiment, when the first connecting portion and the second connecting portion engage, two hooks (110, 111) on either side of the first part (103) are latched onto projections (115, 116) on the second part (105) and secured by the latch lever. Thus the levers impart bias between the first part (103) and the second part (105) and also act as retention means maintaining the bias between the two parts (103, 105).

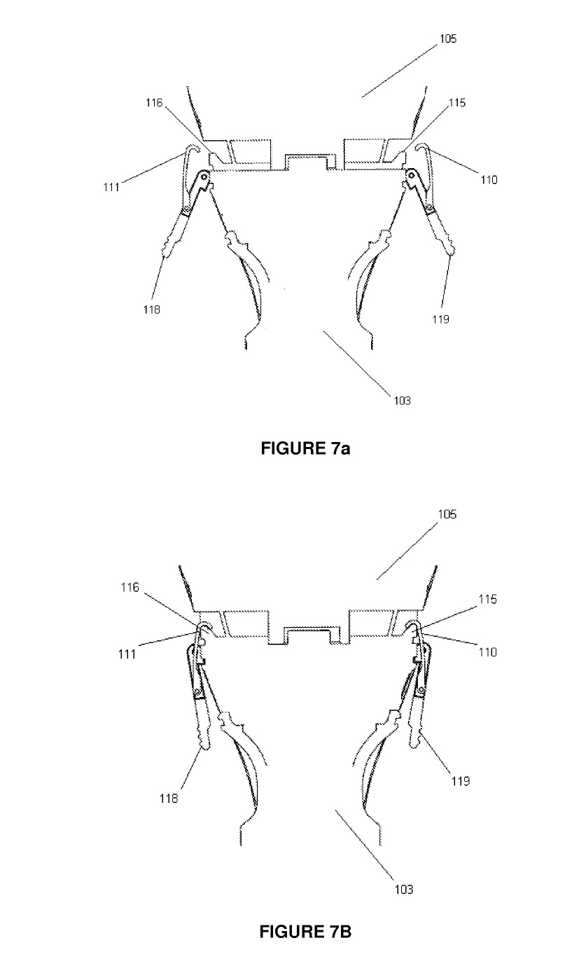

FIG. 7 illustrates the latches of the embodiment shown in FIG. 6 in the disengaged (FIG. 7a) and engaged (FIG. 7b) positions, expanded to show detail. In particular, in this view can be seen the second part (105) having two hooks (110, 111) manually operated by a lever (118, 119) for engaging and disengaging two corresponding projections (115, 116) on the second part (105).

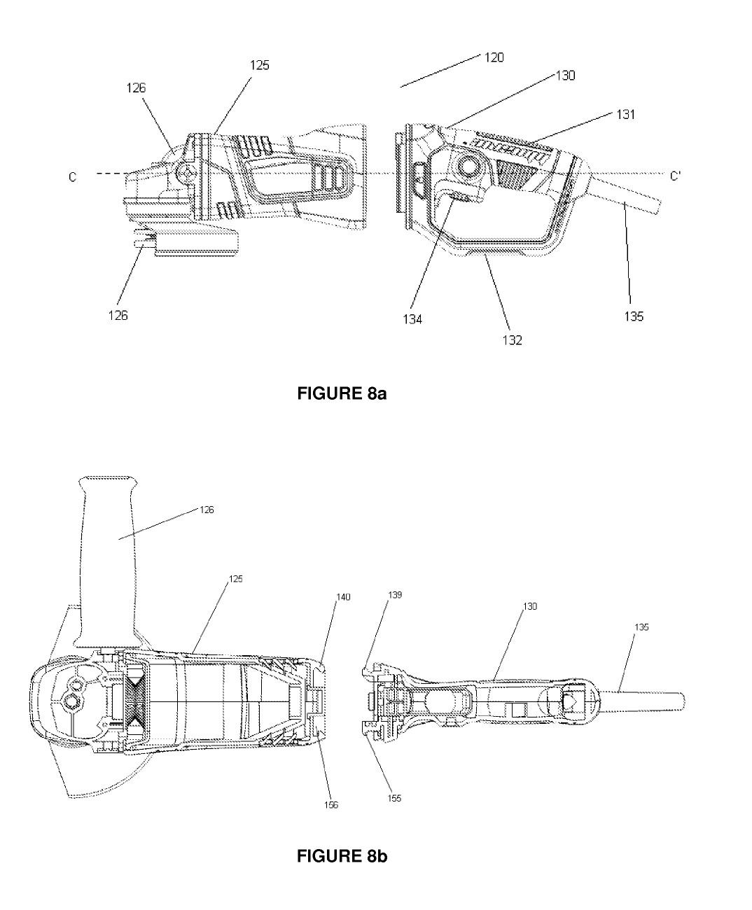

FIG. 8 illustrates a further embodiment of an electro-mechanical device (angle grinder) according to the present invention. FIG. 8a is a side view of the angle grinder (120) having a second part (125) comprising a handle (126) and an angle grinder body supporting a grinding disk (126), and a first part (130) comprising a controller and including a grip (131), hand guard (132) and power actuator trigger (134). The power drill is powered by mains electricity and therefore also includes a power cord (135). In this view the first part and second part are not connected.

FIG. 8b is a view in longitudinal cross section along C-C′ showing detail of the complementary curved shapes of the first connecting portion (139) and second connecting portion (140). The retention means comprises a projection (155) of the second part (130), which is releasably received within a recess (156) in the first part (125) and maintains the bias between the two parts, resisting movement therebetween.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A connection for releasably connecting two parts of an electro-mechanical device, the connection including:
a first connecting portion associated with a first part, and a second connecting portion associated with a second part, such that engagement of the first and second connecting portions imparts bias between the two parts, and
a retention means suitable for maintaining the bias between the two parts.

2. A connection according to claim 1 wherein the electro-mechanical device is a domestic appliance, preferably a power tool.

3. A connection according to claim 1 wherein the first part includes a power source and power actuator, and the second part includes a motor and a working element, the working element preferably chosen from the group comprising drill bits, screw drivers, cutting blades, saws, files, sanding papers/belts, grinding heads and combinations thereof.

4. A connection according to claim 1 wherein the bias substantially stabilises an interface between an electrical contact in the first part and a corresponding electrical contacts in the second part.

5. A connection according to claim 1 wherein engagement between the first connecting portion and the second connecting portion forms a pivot or hinge.

6. A connection according to claim 1 wherein engagement between the first connecting portion and the second connecting portion is interference fit.

7. A connection according to claim 1 wherein engagement between the first connecting portion and the second connecting portion compresses a spring.

8. A connection according to claim 1 wherein the first connecting portion and the second connecting portion are of complementary shape.

9. A connection according to claim 5 wherein the pivot is a hinge having a longitudinal axis substantially parallel to the direction of force applied to the power tool during use.

10. A connection according to claim 5 wherein the pivot is a hinge having a longitudinal axis substantially perpendicular to the direction of force applied to the power tool during use.

11. A connection according to claim 1 wherein the retention means comprises a projection on the first part adapted to be received by the second part.

12. (canceled)

13. A connection according to claim 1 wherein the first part includes a power source supplying alternating current or direct current power.

14. A connection according to claim 1 wherein the first part includes a handle for a user to hold the power tool during use and a first part and at least one operating component.

15. (canceled)

16. A connection according to claim 14 wherein the first part additionally includes a means to disable the power actuator when the first part is disconnected from the second part.

17. A connection according to claim 14 wherein the first part additionally includes a manually operated mechanism to resist separation of the first part from the second part until termination of any flow of power between the first part and second part.

18. (canceled)

19. A connection according to claim 14 wherein the at least one operating component is chosen from the group comprising a electrical flow controller, electrical noise suppression component, FET, actuator or a heat sink.

20. (canceled)

21. (canceled)

22. A method of connecting two parts of a power tool, using the connection of claim 1 including the steps of:
(i) engaging the first connecting portion with the second connecting portion such that bias is imparted between the two parts, and
(ii) simultaneously or subsequently, applying the retention means to maintain bias between the two parts.

23. A method of connecting two parts of a power tool according to claim 22 wherein an actuator is used in step (ii) to change the latch from a first, unlatch, configuration to a second, latched configuration.

24. (canceled)

25. A power tool controller comprising a power source and actuator, suitable for use as a first part or the second part of the power tool of claim 22.

26. A power tool body comprising a motor, suitable for use as a first part or a second part of the power tool of claim 22.
